(19) United States
(12) Patent Application Publication
(10) Pub. No.: US 2021/0019822 A1
(43) Pub. Date: Jan. 21, 2021

(54) ASSOCIATING MERCHANT DATA OR ITEM DATA WITH A MONETARY TRANSACTION BASED ON A LOCATION OF A USER DEVICE

(71) Applicant: Capital One Services, LLC, McLean, VA (US)

(72) Inventors: Joshua EDWARDS, Philadelphia, PA (US); Michael MOSSOBA, Arlington, VA (US); Abdelkadar M'Hamed BENKREIRA, Washington, DC (US)

(21) Appl. No.: 16/515,824

(22) Filed: Jul. 18, 2019

(51) Int. Cl. G06Q 40/02; G06Q 20/40

(52) U.S. Cl. CPC G06Q 40/02; G06Q 20/4093; G06Q 20/405

(57) ABSTRACT

A device may receive withdrawal data identifying a monetary withdrawal transaction. The device may identify a user associated with the monetary withdrawal transaction based on identity data included in the withdrawal data. The device may store the withdrawal amount in a monetary withdrawal record associated with the user. The device may receive location data indicating a location of a user device of the user during a time period. The location may be associated with a merchant. The device may transmit a notification to the user device requesting identification of a monetary purchase transaction performed with the merchant, and may receive a response that includes purchase data. The device may utilize natural language processing on the purchase data to identify an amount spent in the monetary purchase transaction. The device may associate the amount spent and the merchant with the monetary withdrawal record and perform one or more actions.

### BACKGROUND

A transaction device may include an automated teller machine (ATM) device, a point of sale (POS) device, a kiosk device, and/or the like. A user of a transaction device may conduct a variety of transactions via the transaction device, such as receiving money, depositing money, checking an account balance, and/or the like.

### SUMMARY

According to some implementations, a method may include receiving, by a device and from a transaction device, withdrawal data identifying a monetary withdrawal transaction associated with an account of a user, wherein the withdrawal data includes a withdrawal amount of the monetary withdrawal transaction; storing, by the device, the withdrawal amount in a monetary withdrawal record associated with the user; receiving, from a user device associated with the user, after receiving the withdrawal data, location data indicating a location of the user device during a time period, wherein the location is associated with a merchant; transmitting, by the device, a notification to the user device requesting that the user identify a monetary purchase transaction performed with the merchant based on determining that a transaction card transaction of the user did not occur during the time period; receiving, by the device and from the user device, a response that includes purchase data identifying the monetary purchase transaction; utilizing, by the device, natural language processing on the purchase data to identify: an amount spent in the monetary purchase transaction, and an item involved in the monetary purchase transaction; associating, by the device, the amount spent, the merchant, and the item with the monetary withdrawal record; and performing, by the device, one or more actions based on associating the amount spent, the merchant, and the item with the monetary withdrawal record.

According to some implementations, a device may include one or more memories and one or more processors, communicatively coupled to the one or more memories, to receive, from a transaction device, withdrawal data identifying a monetary withdrawal transaction associated with an account, wherein the withdrawal data includes a withdrawal amount of the monetary withdrawal transaction and identity data of a user associated with the monetary withdrawal transaction; identify the user based on the identity data; store the withdrawal amount in a monetary withdrawal record associated with the user based on identifying the user; receive, from a user device associated with the user, after receiving the withdrawal data, location data indicating a location of the user device during a time period, wherein the location is associated with a merchant; transmit a notification to the user device requesting that the user identify a monetary purchase transaction performed with the merchant based on determining that a transaction card transaction of the user did not occur during the time period; receive, from the user device, a response that includes purchase data identifying the monetary purchase transaction; utilize natural language processing on the purchase data to identify an amount spent in the monetary purchase transaction; associate the amount spent and the merchant with the monetary withdrawal record; and perform one or more actions based on associating the amount spent and the merchant with the monetary withdrawal record.

According to some implementations, a non-transitory computer-readable medium may store one or more instructions that, when executed by one or more processors, may cause the one or more processors to receive, from a transaction device, withdrawal data identifying a monetary withdrawal transaction associated with an account of a user, wherein the withdrawal data includes a withdrawal amount of the monetary withdrawal transaction; store the withdrawal amount in a monetary withdrawal record associated with the user; receive, from a user device associated with the user, after receiving the withdrawal data, location data indicating a location of the user device during a time period, wherein the location is associated with a merchant; receive, from the user device of the user, purchase data identifying a monetary purchase transaction executed during the time period; utilize natural language processing on the purchase data to identify an item involved in the monetary purchase transaction; determine an amount spent in the monetary purchase transaction based on at least one of the item or the merchant associated with the location of the user device during the time period; associate the amount spent, information identifying the merchant, and information identifying the item with the monetary withdrawal record; and perform one or more actions based on associating the amount spent, the information identifying the merchant, and the information identifying the item with the monetary withdrawal record.

### BRIEF DESCRIPTION OF THE DRAWINGS

FIGS. 1A-1D are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flow charts of example processes for associating merchant data or item data with a monetary transaction.

### DETAILED DESCRIPTION

The following detailed description of example implementations refers to the accompanying drawings. The same reference numbers in different drawings may identify the same or similar elements.

Sometimes a user utilizes a transaction device to make a monetary withdrawal (e.g., a cash withdrawal) from the transaction device. The user may then spend the cash to purchase items (e.g., goods and/or services) with one or more merchants. A financial system tracks the amount of money withdrawn from the transaction device. For example, the financial system may debit the user's financial account from which the money is withdrawn. Thus, an electronic record may exist regarding the fact that the money has been withdrawn. However, identifying the items, the one or more merchants, and an amount of the withdrawn money spent on each of the items and at each of the one or more merchants is technically complex.

Some implementations described herein provide a recording platform that determines whether a user may have participated in a monetary purchase transaction with a merchant based on a location of a user device of the user and transaction data associated with the merchant. Based on determining that the user may have participated in the monetary purchase transaction with the merchant, the recording platform may transmit a notification to the user device requesting that the user identify the monetary purchase transaction made with the merchant. The recording platform may receive from the user, in response to the notification, purchase data that identifies the monetary purchase transaction. The recording platform may utilize natural language processing on the purchase data to determine an amount spent, a merchant, and/or an item involved in the monetary purchase transaction, and may associate the amount spent, the merchant, and/or the item with a monetary withdrawal record associated with the user.

Accordingly, the recording platform may utilize location data from the user device and transaction data from the merchant to identify a potential monetary purchase transaction of the user. In this way, the recording platform provides accurate identification of potential monetary purchase transactions to thereby facilitate selective, targeted notification transmission. Accordingly, the recording platform conserves resources (e.g., processor resources, memory resources, network resources, and/or the like) associated with notifications that otherwise may be unnecessarily transmitted when potential monetary purchase transactions are not accurately identified.

Furthermore, the recording platform enables associations between monetary withdrawal transactions and monetary purchase transactions that otherwise would require additional reconciliation steps performed by the user, thereby using resources associated with the additional reconciliation steps. For example, without the recording platform, the user may have to log into an account, locate one or more monetary withdrawal transactions, identify portions of the one or more monetary withdrawal transactions that are associated with monetary purchase transactions of the user, and enter information (e.g., in a user interface) associating the portions of the one or more monetary withdrawal transactions with the monetary purchase transactions. Accordingly, the recording platform determines associations between monetary withdrawal transactions and monetary purchase transactions with improved efficiency and with a reduced likelihood of human error. In this way, the recording platform provides improved account organization, budget generation and updating, expenditure tracking, and/or the like.

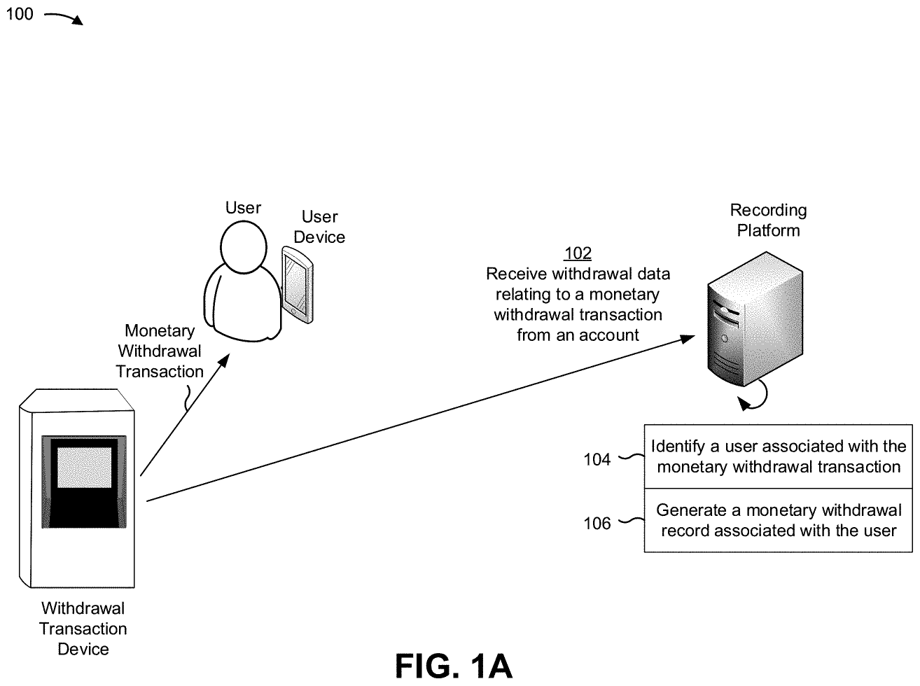

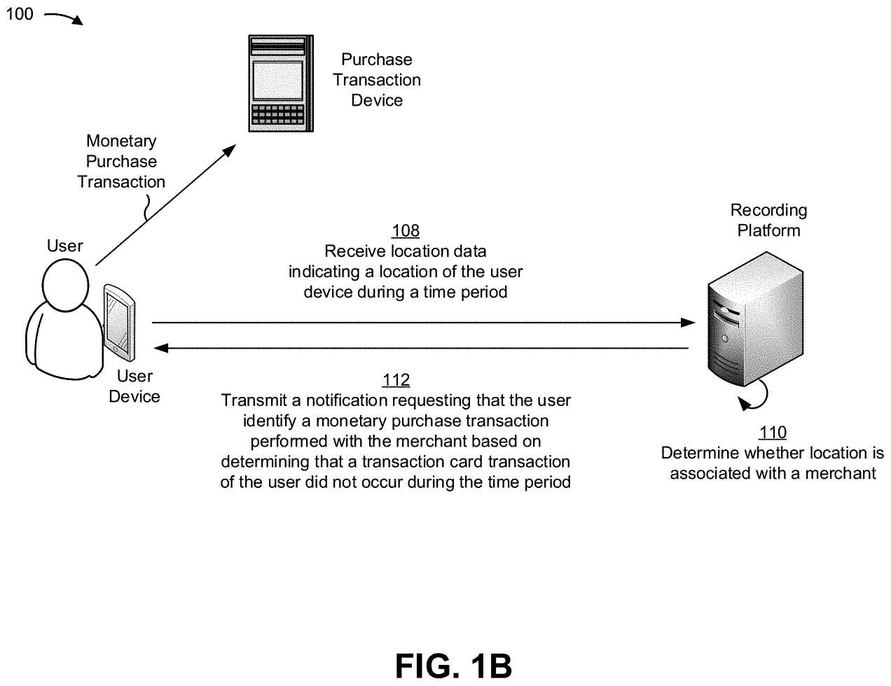

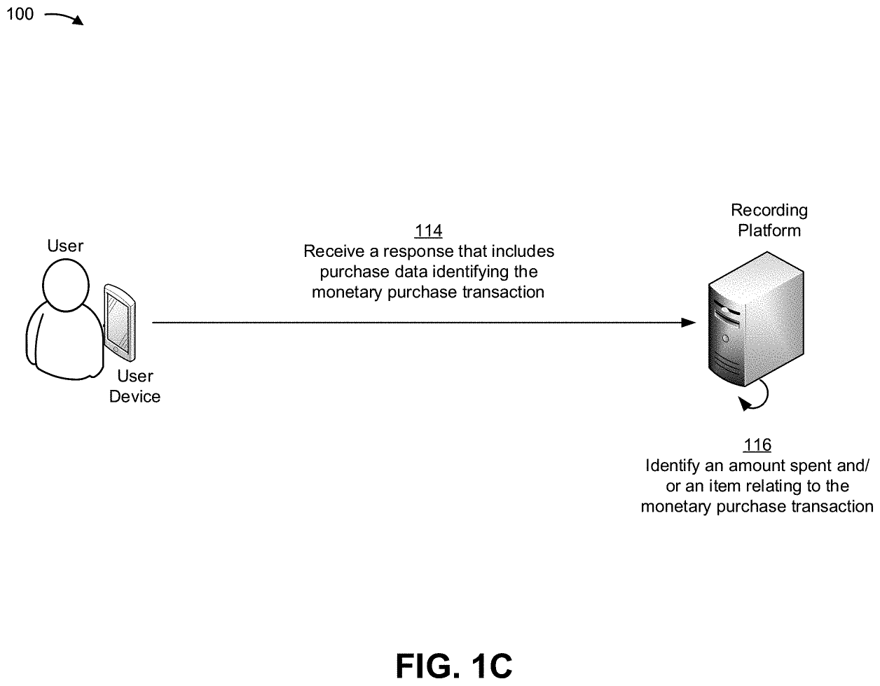

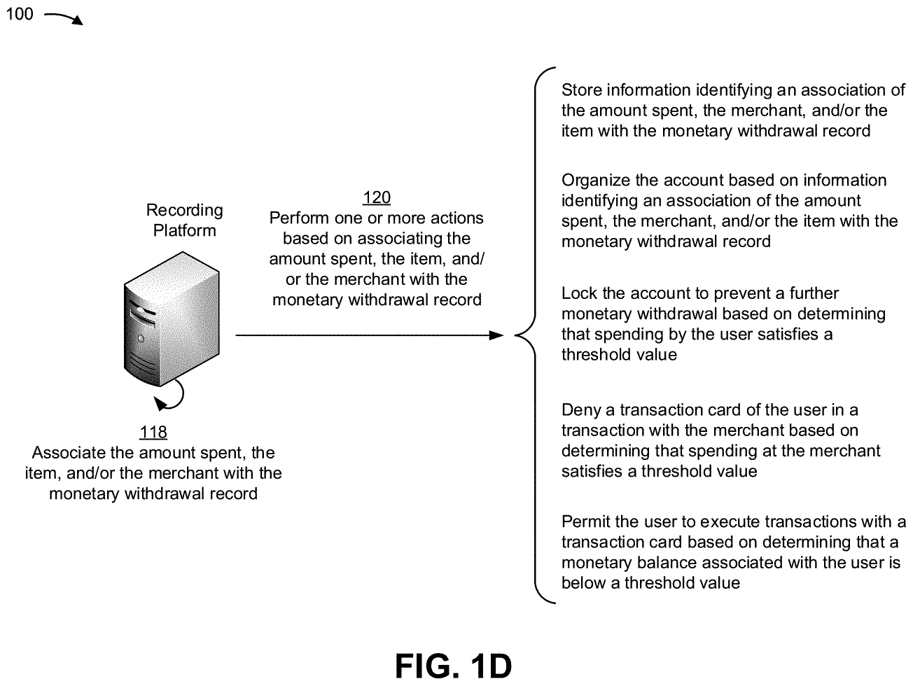

FIGS. 1A-1D are diagrams of one or more example implementations 100 described herein. As shown in FIGS. 1A-1D, example implementation(s) 100 may include a withdrawal transaction device, a purchase transaction device, a user device, and a recording platform.

The withdrawal transaction device (e.g., an ATM device or a POS device) may be an electronic telecommunications device that enables the user to perform a monetary withdrawal transaction (e.g., a cash withdrawal). The withdrawal transaction device may communicate withdrawal data relating to a monetary withdrawal transaction to the recording platform or to another device accessible to the recording platform. The withdrawal transaction device may be associated with an entity, such as a financial institution, a merchant (e.g., a merchant that provides cash withdrawal transactions via an ATM device, a merchant that provides cash-back transactions via a POS device, and/or the like), and/or the like.

The purchase transaction device (e.g., a POS device) may be an electronic telecommunications device that enables the user to perform a purchase transaction. The purchase transaction may be a monetary purchase transaction (e.g., a cash purchase transaction, a cryptocurrency purchase transaction, and/or the like) or a transaction card purchase transaction. In a case of the transaction card purchase transaction, the purchase transaction device may transmit transaction data to the recording platform or to another device accessible to the recording platform. The purchase transaction device may be associated with a merchant. In some implementations, the purchase transaction device and the withdrawal transaction device may be the same device (e.g., a POS device).

The user device (e.g., a smart phone, an internet of things (IoT) device, a wearable communications device, and/or the like) may be associated with a user. For example, the user device may be associated with a user who performs a monetary withdrawal transaction using the withdrawal transaction device. The user device may collect location data (e.g., global positioning system (GPS) data) relating to a location of the user device and transmit the location data to the recording platform.

The recording platform may be a computing device, a server, a cloud computing device, and/or the like that collects and processes information relating to monetary withdrawal transactions from the withdrawal transaction device, purchase transactions from the purchase transaction device, and/or the location of the user device. The recording platform may be associated with a financial institution (e.g., a bank, a credit provider, a transaction processor, and/or the like).

As shown in FIG. 1A, and by reference number 102, the recording platform may receive withdrawal data relating to a monetary withdrawal transaction. For example, the recording platform may receive withdrawal data from the withdrawal transaction device, or another device, in connection with the user performing a monetary withdrawal transaction via the withdrawal transaction device. The monetary withdrawal transaction may relate to a monetary withdrawal (e.g., a cash withdrawal) from an account (e.g., a financial account) associated with the user. The account may be used solely by the user or may be shared between the user and one or more other users.

The withdrawal data may include information relating to the monetary withdrawal transaction, such as a withdrawal amount, a time of the monetary withdrawal transaction, a location of the withdrawal transaction device, and/or the like. The withdrawal data also may include identity data relating to an identity of the user. For example, the identity data may include a personal identification number (PIN) of the user, a biometric identifier (e.g., a fingerprint identifier, a voice identifier, a retinal identifier, and/or the like) of the user, a transaction card (e.g., an ATM card) identifier of the user, and/or the like. In some implementations, the identity data also may include an image of the user. For example, the withdrawal transaction device may include a camera that captures an image of the user when the user is performing a monetary withdrawal transaction.

The monetary withdrawal transaction may relate to a monetary withdrawal from an ATM device or from a POS device. For example, the monetary withdrawal may be a cash-back transaction from a POS device in connection with a transaction card transaction (e.g., a debit card transaction) performed at the POS device. In some implementations, the user may obtain cash without performing a monetary withdrawal transaction. In such a case, the user may obtain cash as a payment to the user. For example, the user may obtain cash from another individual as a payment for a transaction card transaction of the user (e.g., if the user paid for the other individual using a transaction card). The recording platform may receive information relating to cash obtained by the user (e.g., an amount of cash, a time the cash was obtained, and/or the like) from the user device of the user (e.g., the user may transmit, via the user device, a message to the recording platform upon obtaining the cash).

As shown by reference number 104, the recording platform may identify the user associated with the monetary withdrawal transaction. As noted above, the account from which the monetary withdrawal transaction is withdrawn may be associated with multiple users. Accordingly, the recording platform may determine the user from the multiple users associated with the account based on identity data included in the withdrawal data. For example, the recording platform may identify the user based on a PIN of the user (e.g., a PIN unique to the user), a biometric identifier of the user, a transaction card identifier (e.g., a transaction card identifier unique to the user), and/or the like that is included in the identity data. In some implementations, the recording platform may identify the user based on an image of the user that is included in the withdrawal data. For example, the recording platform may identify the user based on processing the image with a facial recognition technique.

In this way, the recording platform can associate the monetary withdrawal transaction with a user that performed the monetary withdrawal transaction (e.g., in a case where multiple users share an account). Based on this association, the recording platform can associate monetary purchase transactions of the user with monetary withdrawal transactions of the user, thereby improving organization and expenditure tracking of the account.

As shown by reference number 106, the recording platform may generate a monetary withdrawal record. For example, the recording platform may generate a monetary withdrawal record that is associated with the identified user. The monetary withdrawal record may be an entry in the account associated with the user (e.g., a debit entry). The recording platform may store, in the monetary withdrawal record, information from the withdrawal data, such as the withdrawal amount, a time of the monetary withdrawal transaction, a location of the withdrawal transaction device, and/or the like. The monetary withdrawal record, when generated, may indicate that the withdrawal amount is unassociated with a monetary purchase transaction. In some implementations, the monetary withdrawal record may be stored in a blockchain (i.e., a distributed ledger) to thereby improve security and accountability of the information stored in the monetary withdrawal record.

As shown by FIG. 1B, and by reference number 108, the recording platform may receive location data indicating a location of the user device of the user (e.g., with permission from the user). The recording platform may receive the location data after the monetary withdrawal transaction. Thus, the location data may relate to a location of the user device during a time period that is after the monetary withdrawal transaction. The location of the user device may, or may not, be associated with a merchant during the time period.

The recording platform may obtain the location data from the user device of the user. Accordingly, the location data may be GPS data (e.g., one or more latitude and longitude coordinates) generated by the user device and transmitted by the user device to the recording platform (e.g., continuously, at configured intervals, and/or the like). The user device may convey the location data via an application executing on the user device.

As shown by reference number 110, the recording platform may determine whether the location of the location data is associated with a merchant. For example, the recording platform may maintain (e.g., in a data structure, such as a data repository, a database, a table, a list, and/or the like), or have access to, merchant location data that maps locations (e.g., latitude and longitude coordinates) to merchants. Accordingly, the recording platform may determine that the location is associated with a merchant, as well as an identity of the merchant, based on the merchant location data.

In some implementations, the recording platform may maintain, or have access to, merchant area data that maps locations to merchant areas. A merchant area may include a building or outdoor area that includes multiple merchants (e.g., a shopping mall), a merchant district (e.g., a shopping or commercial district of a city), and/or the like. In this case, the recording platform may determine that the location is associated with a merchant, but not an identity of the merchant, based on the merchant area data.

In some implementations, the recording platform may identify an entry, and an associated entry time, of the user device into a merchant or a merchant area (e.g., based on the merchant location data or merchant area data) and an exit, and an associated exit time, of the user device from the merchant or the merchant area. In this way, the recording platform may identify a particular time period (e.g., based on the entry time and the exit time) after the monetary withdrawal transaction during which a monetary purchase transaction of the user may occur.

As shown by reference number 112, the recording platform may transmit a notification to the user device requesting that the user identify a monetary purchase transaction performed with the merchant. For example, the recording platform may transmit the notification based on determining that the location of the user device was associated with a merchant and that a transaction card transaction of the user did not occur while the location of the user device was associated with the merchant. As an example, the recording platform may transmit the notification based on determining that the user device was located at the merchant during a time period and that a transaction card transaction of the user did not occur during the time period. The notification may be provided to the user device as a message (e.g., a text message, an email, an application notification, and/or the like).

The recording platform may determine whether a transaction card transaction of the user occurred based on a transaction stream (e.g., an updating, chronological list of transactions) associated with the merchant or the user. For example, the recording platform may monitor, or refer to, the transaction stream to determine whether a transaction card transaction of the user occurred while the location of the user device was associated with a merchant.

As shown by FIG. 1C, and by reference number 114, the recording platform may receive a response, to the notification from the user device, that includes purchase data. The purchase data may identify the monetary purchase transaction performed by the user with the merchant. In some implementations, the response from the user device may indicate that no monetary purchase transaction was performed by the user with the merchant.

The purchase data may include a name or a description of the merchant, a name or a description of an item purchased, or an amount of the monetary purchase transaction. The user may provide the purchase data in the response as a verbal narrative (e.g., the user may speak the purchase data into an application executing on the user device), a textual narrative, and/or as structured data (e.g., the user may enter the purchase data into a user interface generated by the recording platform). The user device may transmit the response to the recording platform as a message (e.g., a text message, an email, an application message, and/or the like).

As shown by reference number 116, the recording platform may identify an amount spent by the user or an item purchased by the user in connection with the monetary purchase transaction. In some implementations, such as when the recording platform cannot identify a merchant from the location data, the recording platform may identify a merchant associated with the monetary purchase transaction. The recording platform may identify the amount spent, the item, and/or the merchant based on the purchase data in the response from the user device.

In some implementations, the recording platform may identify the amount spent, the item, and/or the merchant based on structured data included in the response. In some implementations, such as when the purchase data includes a verbal narrative or a textual narrative of the monetary purchase transaction, the recording platform may utilize a natural language processing technique, a computational linguistics technique, a text analysis technique, and/or the like, with the purchase data in order to identify the amount spent, the item, and/or the merchant. The recording platform may apply natural language processing to interpret the purchase data and generate additional data associated with the potential meaning of the purchase data. For example, based on a verbal narrative or a textual narrative of a monetary purchase transaction being “five dollars for socks,” the recording platform may use natural language processing to determine that an item of the monetary purchase transaction is socks and an amount of the monetary purchase transaction is $5.00.

Natural language processing involves techniques performed (e.g., by a computer system) to analyze, understand, and derive meaning from human language in a useful way. Rather than treating text like a mere sequence of symbols, natural language processing considers a hierarchical structure of language (e.g., several words can be treated as a phrase, several phrases can be treated as a sentence, and the words, phrases, and/or sentences convey ideas that can be interpreted). Natural language processing can be applied to analyze text, allowing machines to understand how humans speak, enabling real world applications such as automatic text summarization, sentiment analysis, topic extraction, named entity recognition, parts-of-speech tagging, relationship extraction, stemming, and/or the like.

In some implementations, the recording platform may predict the amount spent, the item, and/or the merchant based on the purchase data. For example, if the item and the merchant are provided in the purchase data, but the purchase data does not provide the amount spent, the recording platform may predict the amount spent based on historical transactions associated with the item and the merchant (e.g., historical transactions performed by the user or by a plurality of users). As an example, if the purchase data indicates that a slice of pizza was purchased at Joe's Pizza, the recording platform may predict that the amount spent on the slice of pizza was $3.00 based on one or more historical transactions involving a purchase of a slice of pizza from Joe's Pizza for $3.00.

As another example, if the amount spent and the merchant are provided in the purchase data, but the purchase data does not provide the item, the recording platform may predict the item based on historical transactions associated with the amount spent and the merchant. For example, if the purchase data indicates that $3.00 was spent at Joe's Pizza, the recording platform may predict that the item purchased was a slice of pizza based on one or more historical transactions involving a purchase of a slice of pizza from Joe's Pizza for $3.00. In this way, the recording platform can improve the accuracy of the purchase data and conserve computing resources that may otherwise be used to later identify, investigate, and/or rectify incorrect purchase data.

In some implementations, the recording platform may use a machine learning model to predict the amount spent, the item, and/or the merchant based on the purchase data. For example, the recording platform may train the machine learning model based on one or more parameters associated with monetary purchase transactions, such as amounts spent, items, merchants, and/or the like. The recording platform may train the machine learning model, according to the one or more parameters, using historical transaction data associated with monetary purchase transactions. Using the historical transaction data and the one or more parameters as inputs to the machine learning model, the recording platform may predict an amount spent in a monetary purchase transaction based on an item and/or a merchant identified in the purchase data, may predict an item in a monetary purchase transaction based on an amount spent and/or a merchant identified in the purchase data, and/or may predict merchant in a monetary purchase transaction based on an item and/or an amount spent identified in the purchase data. In some implementations, the recording platform may obtain and utilize a machine learning model that was trained by another device.

In some implementations, such as when the recording platform has identified a merchant from the location data, the recording platform may communicate with a device (e.g., a server device) of the merchant to obtain information relating to transactions with the merchant. For example, the recording platform may obtain information (e.g., item information, amount spent information, and/or the like) relating to cash transactions with the merchant that occurred during the time period and that involved an amount spent less than or equal to the monetary withdrawal transaction of the user. The device of the merchant may anonymize the information so that personal information is not revealed. In some implementations, the recording platform may determine a correlation between the purchase data and the information to thereby confirm the item and/or the amount spent determined by the recording platform. Additionally, or alternatively, the notification transmitted by the recording platform (i.e., the notification requesting that the user identify the monetary purchase transaction) may include a list of transactions (e.g., transactions identified from the information), from which the user may select the item and/or the amount spent to be included in the response to the notification. In this way, the recording platform can improve the accuracy of the purchase data and conserve computing resources that may otherwise be used to later identify, investigate, and/or rectify incorrect purchase data.

As shown by FIG. 1D, and by reference number 118, the recording platform may associate the amount spent, the item (e.g., information identifying the item, such as an item code), and/or the merchant (e.g., information identifying the merchant, such as a merchant code) of the monetary purchase transaction with a monetary withdrawal record. For example, the recording platform may associate the amount spent, the item, and/or the merchant of the monetary purchase transaction of the user with a monetary withdrawal record of the user. The recording platform may associate the amount spent, the item, and/or the merchant of the monetary purchase transaction with an unassociated portion of the monetary withdrawal record. That is, the recording platform may associate the amount spent, the item, and/or the merchant with an unassociated portion of the withdrawal amount of the monetary withdrawal record (e.g., a portion of the withdrawal amount that is not associated with an amount spent relating to a previous monetary purchase transaction). In such a case, a monetary withdrawal record may be associated with metadata that may indicate a portion of the monetary withdrawal record that is unassociated.

In this way, the recording platform determines associations between monetary withdrawal transactions and monetary purchase transactions with improved accuracy and without human error, thereby improving account organization and expenditure tracking. Accordingly, the recording platform can conserve computing resources that may otherwise be used to later identify, investigate, and/or rectify incorrect associations.

Since there may be multiple monetary withdrawal records associated with the user, the recording platform may first determine a particular monetary withdrawal record associated with the user that is to be associated with the amount spent, the item, and/or the merchant of the monetary purchase transaction. In such a case, the particular monetary withdrawal record may be a monetary withdrawal record that has an unassociated portion (e.g., the particular monetary withdrawal record is associated with one or more monetary purchase transactions that have an aggregate amount spent that is less than the withdrawal amount associated with the particular monetary withdrawal record). For example, the withdrawal amount of the particular monetary withdrawal record may be $100, and the particular monetary withdrawal record may be associated with monetary purchase transactions that have an aggregate amount spent of $70, such that an unassociated portion of the particular monetary withdrawal record is $30. In some implementations, the recording platform may determine the particular monetary withdrawal record as an earliest (e.g., earliest in time) monetary withdrawal record that has an unassociated portion.

In some implementations, the amount spent of a monetary purchase transaction may be greater than an unassociated portion of a monetary withdrawal record. In this case, the recording platform may associate a first portion of the amount spent, as well as the item and/or the merchant, with the monetary withdrawal record (e.g., an earliest monetary withdrawal record that has an unassociated portion) and a second portion of the amount spent, as well as the item and/or the merchant, with another monetary withdrawal record (e.g., a next-earliest monetary withdrawal record that has an unassociated portion). For example, if a monetary purchase transaction has an amount spent of $100, a first monetary withdrawal record has an unassociated portion of $40, and a second monetary withdrawal record has an unassociated portion of $200, the recording platform may associate $40 of the amount spent with the first monetary withdrawal record and $60 of the amount spent (e.g., the remainder) with the second monetary withdrawal record.

In some implementations, the recording platform may determine a category associated with the item (e.g., groceries, electronics, gasoline, and/or the like) and/or the merchant (e.g., bookstore, pharmacy, restaurant, and/or the like) of the monetary purchase transaction. In some implementations, the recording platform may determine the category according to an item commodity code determined to be associated with the item and/or a merchant category code determined to be associated with the merchant. Additionally, or alternatively, the recording platform may use a machine learning model to determine a category associated with the item and/or the merchant, in a manner similar to that described above.

The recording platform may associate the amount spent of the monetary purchase transaction with the determined category. In this way, the recording platform facilitates spending tracking within a category of item and/or merchant. The recording platform also may associate an indicator with the monetary purchase transaction, the indicator providing an indication of whether the monetary purchase transaction relates to a merchant-level transaction and/or an item-level transaction.

In some implementations, the recording platform may generate a monetary withdrawal record relating to cash obtained by the user (e.g., cash obtained by the user without performing a monetary withdrawal transaction), as described above. In this case, the recording platform may associate the amount spent, the item, and/or the merchant of the monetary purchase transaction with the monetary withdrawal record relating to cash obtained by the user, in a manner similar to that described above. In addition, the recording platform may determine a transaction card transaction associated with the cash obtained by the user and reduce the transaction card transaction by the amount spent. The transaction card transaction may be associated with the cash obtained by the user when the cash is a payment to the user for a transaction card transaction performed by the user (e.g., on behalf of another individual). The recording platform may determine that the cash obtained by the user is associated with the transaction card transaction based on a response from the user to a notification transmitted by the recording platform (e.g., a notification requesting that the user identify whether a monetary purchase transaction used cash obtained without a monetary withdrawal transaction). In some implementations, the recording platform may transmit the notification based on determining that there is no monetary withdrawal record associated with the user that has an unassociated portion.

As shown by reference number 120, the recording platform may perform one or more actions based on associating the amount spent, the item, and/or the merchant of the monetary purchase transaction with the monetary withdrawal record. For example, the recording platform may store information (e.g., in a data structure, such as a data repository, a database, a table, a list, and/or the like) that identifies an association of the amount spent, the item, and/or the merchant and the monetary withdrawal record.

In some implementations, the one or more actions may include the recording platform organizing the account based on the information identifying the association of the amount spent, the item, and/or the merchant with the monetary withdrawal record. In such a case, the recording platform may generate a user interface that lists amount information, item information, and/or merchant information for a monetary purchase transaction adjacent (e.g., above or below) a monetary withdrawal record that is associated with the monetary purchase transaction. Additionally, the recording platform may organize the account by generating a record for the monetary purchase transaction (e.g., a record that includes the amount spent, the item, and/or the merchant), associating the record with the monetary withdrawal record (e.g., listing the record adjacent the monetary withdrawal record in a user interface), and updating the withdrawal amount of the monetary withdrawal record with an updated withdrawal amount (e.g., the withdrawal amount less the amount spent of the monetary purchase transaction). In this way, the recording platform enables the user to review information stored by the recording platform and easily determine a manner in which the user is spending monetary withdrawals.

In some implementations, the one or more actions may include the recording platform generating and/or updating a budget for the user based on the association of the amount spent, the item, and/or the merchant with the monetary withdrawal record. In addition, the one or more actions may include the recording platform generating and/or updating a budget for the user based on the amount spent and a category determined for the item and/or the merchant. In this way, the recording platform enables the user to efficiently generate or update budgets based on monetary withdrawals, which conserves resources that would otherwise be wasted attempting to organize and calculate a budget without associations determined by the recording platform.

In some implementations, the one or more actions may include the recording platform generating a search result based on the association of the amount spent, the item, and/or the merchant with the monetary withdrawal record. Additionally, the search result may be based on a category or an indicator associated with the monetary purchase transaction. For example, the user may perform a search for monetary withdrawals relating to a particular time period, a particular item, a particular merchant, a particular category, and/or the like and the recording platform may generate a search result based on the search. As another example, the user may perform a search for monetary withdrawals that relate to item-level transactions and/or merchant-level transactions and the recording platform may generate a search result based on the search. In this way, the recording platform enables the user to quickly and efficiently identify particular monetary withdrawals of interest to the user, which conserves computing resources relative to slower and less efficient techniques.

In some implementations, the one or more actions may include the recording platform locking the account so as to prevent a further monetary withdrawal from the account for a particular time period (e.g., a day, a week, a month, and/or the like) based on determining that spending (e.g., monetary spending, transaction card spending, and/or the like) during the time period satisfies a threshold value. In such a case, the recording platform may lock the account so as to prevent a particular user from performing a further monetary withdrawal from the account for a particular time period based on determining that spending by the particular user during the time period satisfies a threshold value.

In some implementations, the one or more actions may include denying a transaction card associated with the account in a transaction with a merchant for a particular time period (e.g., a day, a week, a month, and/or the like) based on determining that spending (e.g., monetary spending, transaction card spending, and/or the like) at the merchant, by the account, during the particular time period satisfies a threshold value. For example, the recording platform may deny a transaction card of a particular user for a particular time period based on determining that spending by the particular user during the time period satisfies a threshold value.

In some implementations, the one or more actions may include permitting a user to execute transactions with a transaction card based on determining that a monetary balance associated with the user for a particular time period (e.g., a day, a week, a month, and/or the like) is below a threshold value. The monetary balance may relate to monetary purchase transactions and/or transaction card transactions associated with the user over the particular time period.

In some implementations, the recording platform may transmit a notification to the user device of the user indicating that the account is to be locked, the transaction card of the user is to be declined, transaction card transactions by the user are to be permitted, and/or the like. A notification also may indicate a monetary balance associated with the user, a total amount of monetary purchase transactions performed by the user during a particular time period, a list of items and/or merchants associated with the monetary purchase transactions performed by the user, and/or the like. Additionally, the recording platform may determine a total amount of spending by the user (e.g., monetary spending, transaction card spending, and/or the like) that is associated with a particular category of item and/or merchant. The recording platform may transmit a notification to the user device when the total amount of spending associated with the particular category of item and/or merchant satisfies a threshold value.

As indicated above, FIGS. 1A-1D are provided as one or more examples. Other examples may differ from what is described with regard to FIGS. 1A-1D.

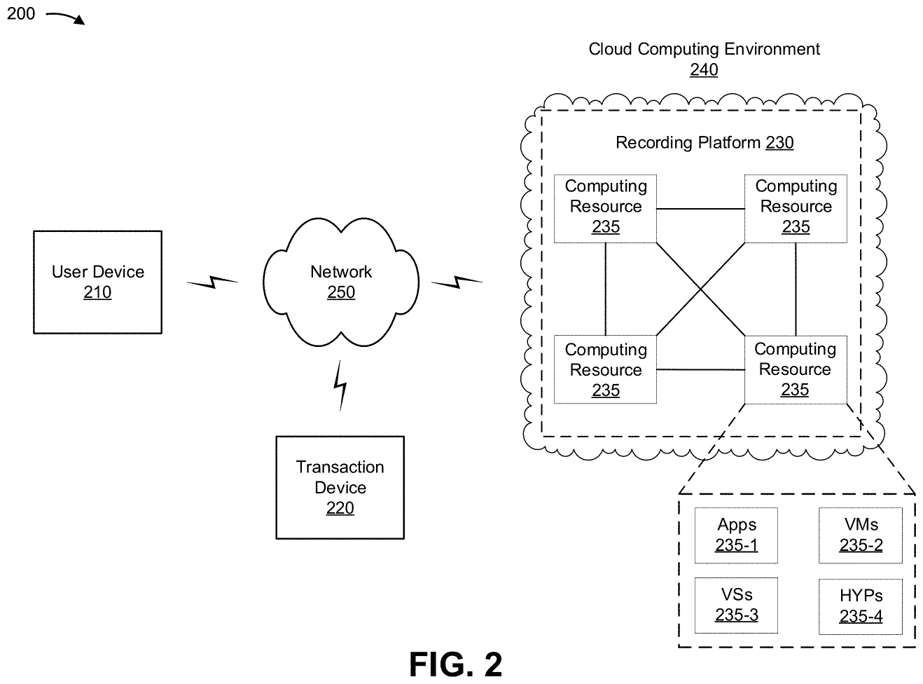

FIG. 2 is a diagram of an example environment 200 in which systems and/or methods, described herein, may be implemented. As shown in FIG. 2, environment 200 may include a user device 210, a transaction device 220, a recording platform 230, a computing resource 235, a cloud computing environment 240, and a network 250. Devices of environment 200 may interconnect via wired connections, wireless connections, or a combination of wired and wireless connections.

User device 210 includes one or more devices capable of receiving, generating, storing, processing, and/or providing information associated with providing location data and/or receiving notifications. For example, user device 210 may include a communication and/or computing device, such as a mobile phone (e.g., a smart phone, a radiotelephone, and/or the like), a laptop computer, a tablet computer, a handheld computer, a gaming device, a wearable communication device (e.g., a smart wristwatch, a pair of smart eyeglasses, and/or the like), or a similar type of device.

Transaction device 220 includes one or more devices capable of receiving, generating, storing, processing, and/or providing information, such as information described herein. For example, transaction device 220 may include an ATM device, a POS device, a kiosk device, and/or the like. An ATM device may include an electronic telecommunications device that enables customers of financial institutions to perform financial transactions, such as cash withdrawals, deposits, transferring funds, obtaining account information, and/or the like, at any time and without direct interaction with employees of the financial institutions. A POS device may include an electronic device used to process transactions at retail locations. The POS device may read information from a transaction card (e.g., a credit card, a debit card, a gift card, and/or the like), and may determine whether there are sufficient funds in an account associated with the transaction card for a transaction. The POS device may transfer funds from the account associated with the transaction card to an account of a retailer and may record the transaction. A kiosk device may include a computer terminal featuring specialized hardware and software that provides access to information and/or applications for communication, commerce, entertainment, education, and/or the like. Some implementations described herein may include a withdrawal transaction device (e.g., an ATM device) that processes a monetary withdrawal transaction and a purchase transaction device (e.g., a POS device) that processes a monetary purchases transaction.

Recording platform 230 includes one or more computing resources assigned to obtain transaction information, track a location of a user device, transmit and receive notifications, and determine associations between transactions. For example, recording platform 230 may be a platform implemented by cloud computing environment 240 that may obtain information relating to a monetary withdrawal transaction, determine an identity of a user associated with the monetary withdrawal transaction, track a location of a user device associated with the user, obtain information relating to transaction card transactions of a merchant, transmit a notification to the user device, receive a response to the notification from the user device, determine an association of a monetary purchase transaction of the user and a monetary withdrawal record of the user, perform one or more actions based on the association, and/or the like. In some implementations, recording platform 230 is implemented by computing resources 235 of cloud computing environment 240.

Recording platform 230 may include a server device or a group of server devices. In some implementations, recording platform 230 may be hosted in cloud computing environment 240. Notably, while implementations described herein may describe recording platform 230 as being hosted in cloud computing environment 240, in some implementations, recording platform 230 may be non-cloud-based or may be partially cloud-based.

Cloud computing environment 240 includes an environment that delivers computing as a service, whereby shared resources, services, and/or the like may be provided to user device 210, transaction device 220, and/or the like. Cloud computing environment 240 may provide computation, software, data access, storage, and/or other services that do not require end-user knowledge of a physical location and configuration of a system and/or a device that delivers the services. As shown, cloud computing environment 240 may include recording platform 230 and computing resource 235.

Computing resource 235 includes one or more personal computers, workstation computers, server devices, or another type of computation and/or communication device. In some implementations, computing resource 235 may host recording platform 230. The cloud resources may include compute instances executing in computing resource 235, storage devices provided in computing resource 235, data transfer devices provided by computing resource 235, and/or the like. In some implementations, computing resource 235 may communicate with other computing resources 235 via wired connections, wireless connections, or a combination of wired and wireless connections.

As further shown in FIG. 2, computing resource 235 may include a group of cloud resources, such as one or more applications (“APPs”) 235-1, one or more virtual machines (“VMs”) 235-2, virtualized storage (“VSs”) 235-3, one or more hypervisors (“HYPs”) 235-4, or the like.

Application 235-1 includes one or more software applications that may be provided to or accessed by user device 210, transaction device 220, and/or the like. Application 235-1 may eliminate a need to install and execute the software applications on user device 210, transaction device 220, and/or the like. For example, application 235-1 may include software associated with recording platform 230 and/or any other software capable of being provided via cloud computing environment 240. In some implementations, one application 235-1 may send/receive information to/from one or more other applications 235-1, via virtual machine 235-2.

Virtual machine 235-2 includes a software implementation of a machine (e.g., a computer) that executes programs like a physical machine. Virtual machine 235-2 may be either a system virtual machine or a process virtual machine, depending upon use and degree of correspondence to any real machine by virtual machine 235-2. A system virtual machine may provide a complete system platform that supports execution of a complete operating system (“OS”). A process virtual machine may execute a single program and may support a single process. In some implementations, virtual machine 235-2 may execute on behalf of a user, and may manage infrastructure of cloud computing environment 240, such as data management, synchronization, or long-duration data transfers.

Virtualized storage 235-3 includes one or more storage systems and/or one or more devices that use virtualization techniques within the storage systems or devices of computing resource 235. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 235-4 provides hardware virtualization techniques that allow multiple operating systems (e.g., “guest operating systems”) to execute concurrently on a host computer, such as computing resource 235. Hypervisor 235-4 may present a virtual operating platform to the guest operating systems and may manage the execution of the guest operating systems. Multiple instances of a variety of operating systems may share virtualized hardware resources.

Network 250 includes one or more wired and/or wireless networks. For example, network 250 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The quantity and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

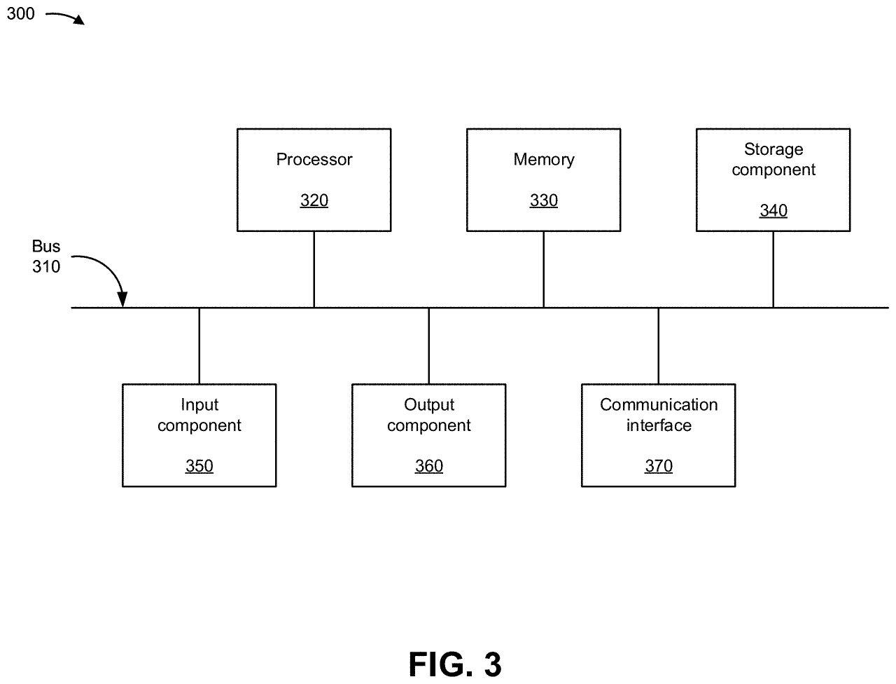

FIG. 3 is a diagram of example components of a device 300. Device 300 may correspond to user device 210, transaction device 220, recording platform 230, and/or computing resource 235. In some implementations, user device 210, transaction device 220, recording platform 230, and/or computing resource 235 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among multiple components of device 300. Processor 320 is implemented in hardware, firmware, and/or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The quantity and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

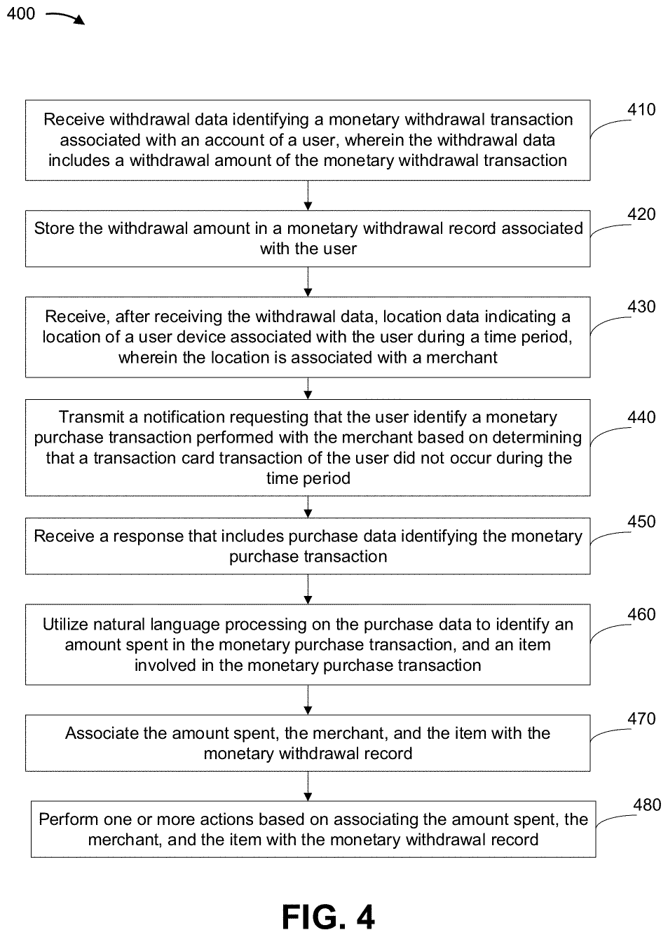

FIG. 4 is a flow chart of an example process 400 for associating merchant data or item data with a monetary transaction. In some implementations, one or more process blocks of FIG. 4 may be performed by a recording platform (e.g., recording platform 230). In some implementations, one or more process blocks of FIG. 4 may be performed by another device or a group of devices separate from or including the recording platform, such as a user device (e.g., user device 210), a transaction device (e.g., transaction device 220), and/or the like.

As shown in FIG. 4, process 400 may include receiving withdrawal data identifying a monetary withdrawal transaction associated with an account of a user, wherein the withdrawal data includes a withdrawal amount of the monetary withdrawal transaction (block 410). For example, the recording platform (e.g., using computing resource 235, processor 320, memory 330, storage component 340, input component 350, communication interface 370, and/or the like) may receive withdrawal data identifying a monetary withdrawal transaction associated with an account of a user, as described above. In some implementations, the withdrawal data includes a withdrawal amount of the monetary withdrawal transaction.

As further shown in FIG. 4, process 400 may include storing the withdrawal amount in a monetary withdrawal record associated with the user (block 420). For example, the recording platform (e.g., using computing resource 235, processor 320, memory 330, storage component 340, and/or the like) may store the withdrawal amount in a monetary withdrawal record associated with the user, as described above.

As further shown in FIG. 4, process 400 may include receiving, after receiving the withdrawal data, location data indicating a location of a user device associated with the user during a time period, wherein the location is associated with a merchant (block 430). For example, the recording platform (e.g., using computing resource 235, processor 320, memory 330, storage component 340, input component 350, communication interface 370, and/or the like) may receive, after receiving the withdrawal data, location data indicating a location of a user device associated with the user during a time period, as described above. In some implementations, the location is associated with a merchant.

As further shown in FIG. 4, process 400 may include transmitting a notification requesting that the user identify a monetary purchase transaction performed with the merchant based on determining that a transaction card transaction of the user did not occur during the time period (block 440). For example, the recording platform (e.g., using computing resource 235, processor 320, memory 330, storage component 340, output component 360, communication interface 370, and/or the like) may transmit a notification requesting that the user identify a monetary purchase transaction performed with the merchant based on determining that a transaction card transaction of the user did not occur during the time period, as described above.

As further shown in FIG. 4, process 400 may include receiving a response that includes purchase data identifying the monetary purchase transaction (block 450). For example, the recording platform (e.g., using computing resource 235, processor 320, memory 330, storage component 340, input component 350, communication interface 370, and/or the like) may receive a response that includes purchase data identifying the monetary purchase transaction, as described above.

As further shown in FIG. 4, process 400 may include utilizing natural language processing on the purchase data to identify an amount spent in the monetary purchase transaction and an item involved in the monetary purchase transaction (block 460). For example, the recording platform (e.g., using computing resource 235, processor 320, memory 330, storage component 340, and/or the like) may utilize natural language processing on the purchase data to identify an amount spent in the monetary purchase transaction and an item involved in the monetary purchase transaction, as described above.

As further shown in FIG. 4, process 400 may include associating the amount spent, the merchant, and the item with the monetary withdrawal record (block 470). For example, the recording platform (e.g., using computing resource 235, processor 320, memory 330, storage component 340, and/or the like) may associate the amount spent, the merchant, and the item with the monetary withdrawal record, as described above.

As further shown in FIG. 4, process 400 may include performing one or more actions based on associating the amount spent, the merchant, and the item with the monetary withdrawal record (block 480). For example, the recording platform (e.g., using computing resource 235, processor 320, memory 330, storage component 340, input component 350, output component 360, communication interface 370, and/or the like) may perform one or more actions based on associating the amount spent, the merchant, and the item with the monetary withdrawal record, as described above.

Process 400 may include additional implementations, such as any single implementation or any combination of implementations described below and/or in connection with one or more other processes described elsewhere herein.

In a first implementation, performing the one or more actions may include one or more of storing information identifying an association of the amount spent, the merchant, and the item with the monetary withdrawal record, organizing the account based on the information identifying the association of the amount spent, the merchant, and the item with the monetary withdrawal record, locking the account to prevent a further monetary withdrawal based on determining that spending by the user satisfies a first threshold value, denying a transaction card of the user in a transaction with the merchant based on determining that spending at the merchant satisfies a second threshold value, or permitting the user to execute transactions with the transaction card based on determining that a monetary balance associated with the user is below a third threshold value. In a second implementation, alone or in combination with the first implementation, organizing the account may include generating a record that includes the amount spent, the merchant, and the item, and updating the withdrawal amount of the monetary withdrawal record with an updated withdrawal amount that is the withdrawal amount less the amount spent.

In a third implementation, alone or in combination with one or more of the first and second implementations, process 400 further may include determining that the location of the user device is associated with the merchant based on GPS coordinates associated with the user device and the merchant. In a fourth implementation, alone or in combination with one or more of the first through third implementations, the monetary withdrawal record may be a first monetary withdrawal record, and associating the amount spent, the merchant, and the item with the monetary withdrawal record may include associating a first portion of the amount spent, the merchant, and the item with the first monetary withdrawal record and a second portion of the amount spent, the merchant, and the item with a second monetary withdrawal record based on determining that the amount spent is greater than the withdrawal amount of the first monetary withdrawal record.

In a fifth implementation, alone or in combination with one or more of the first through fourth implementations, process 400 further may include determining a category associated with the item, and associating the amount spent with the category. In a sixth implementation, alone or in combination with one or more of the first through fifth implementations, performing the one or more actions may include transmitting an alert to the user device based on determining that spending in the category satisfies a threshold value.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

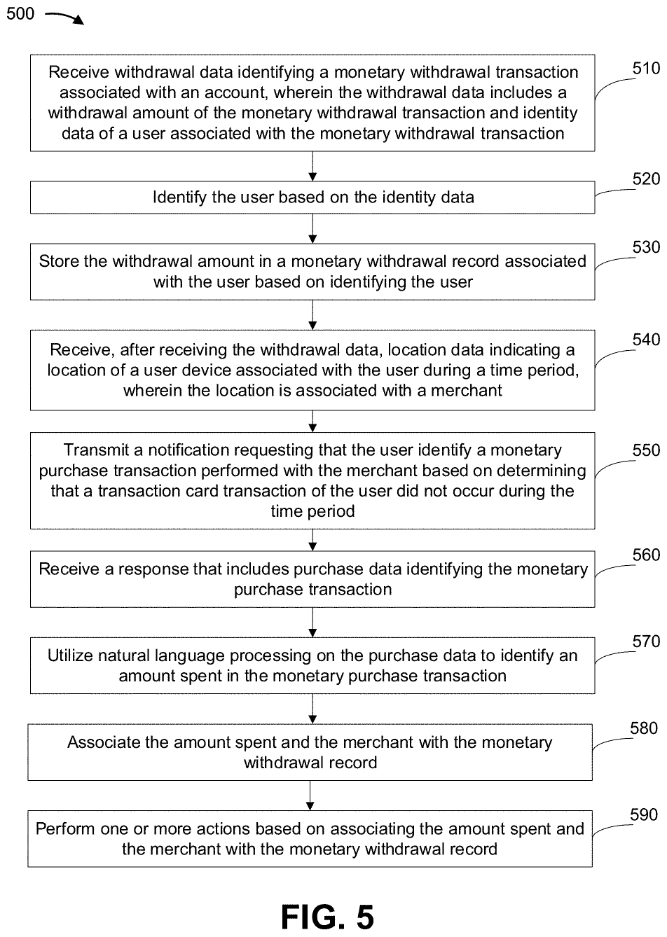

FIG. 5 is a flow chart of an example process 500 for associating merchant data or item data with a monetary transaction. In some implementations, one or more process blocks of FIG. 5 may be performed by a recording platform (e.g., recording platform 230). In some implementations, one or more process blocks of FIG. 5 may be performed by another device or a group of devices separate from or including the recording platform, such as a user device (e.g., user device 210), a transaction device (e.g., transaction device 220), and/or the like.

As shown in FIG. 5, process 500 may include receiving withdrawal data identifying a monetary withdrawal transaction associated with an account, wherein the withdrawal data includes a withdrawal amount of the monetary withdrawal transaction and identity data of a user associated with the monetary withdrawal transaction (block 510). For example, the recording platform (e.g., using computing resource 235, processor 320, memory 330, storage component 340, input component 350, communication interface 370, and/or the like) may receive withdrawal data identifying a monetary withdrawal transaction associated with an account, as described above. In some implementations, the withdrawal data includes a withdrawal amount of the monetary withdrawal transaction and identity data of a user associated with the monetary withdrawal transaction.

As further shown in FIG. 5, process 500 may include identifying the user based on the identity data (block 520). For example, the recording platform (e.g., using computing resource 235, processor 320, memory 330, storage component 340, and/or the like) may identify the user based on the identity data, as described above.

As further shown in FIG. 5, process 500 may include storing the withdrawal amount in a monetary withdrawal record associated with the user based on identifying the user (block 530). For example, the recording platform (e.g., using computing resource 235, processor 320, memory 330, storage component 340, and/or the like) may store the withdrawal amount in a monetary withdrawal record associated with the user based on identifying the user, as described above.

As further shown in FIG. 5, process 500 may include receiving, after receiving the withdrawal data, location data indicating a location of a user device associated with the user during a time period, wherein the location is associated with a merchant (block 540). For example, the recording platform (e.g., using computing resource 235, processor 320, memory 330, storage component 340, input component 350, communication interface 370, and/or the like) may receive, after receiving the withdrawal data, location data indicating a location of a user device associated with the user during a time period, as described above. In some implementations, the location is associated with a merchant.

As further shown in FIG. 5, process 500 may include transmitting a notification requesting that the user identify a monetary purchase transaction performed with the merchant based on determining that a transaction card transaction of the user did not occur during the time period (block 550). For example, the recording platform (e.g., using computing resource 235, processor 320, memory 330, storage component 340, output component 360, communication interface 370, and/or the like) may transmit a notification requesting that the user identify a monetary purchase transaction performed with the merchant based on determining that a transaction card transaction of the user did not occur during the time period, as described above.

As further shown in FIG. 5, process 500 may include receiving a response that includes purchase data identifying the monetary purchase transaction (block 560). For example, the recording platform (e.g., using computing resource 235, processor 320, memory 330, storage component 340, input component 350, communication interface 370, and/or the like) may receive a response that includes purchase data identifying the monetary purchase transaction, as described above.

As further shown in FIG. 5, process 500 may include utilizing natural language processing on the purchase data to identify an amount spent in the monetary purchase transaction (block 570). For example, the recording platform (e.g., using computing resource 235, processor 320, memory 330, storage component 340, and/or the like) may utilize natural language processing on the purchase data to identify an amount spent in the monetary purchase transaction and an item involved in the monetary purchase transaction, as described above.

As further shown in FIG. 5, process 500 may include associating the amount spent and the merchant with the monetary withdrawal record (block 580). For example, the recording platform (e.g., using computing resource 235, processor 320, memory 330, storage component 340, and/or the like) may associate the amount spent and the merchant with the monetary withdrawal record, as described above.

As further shown in FIG. 5, process 500 may include performing one or more actions based on associating the amount spent and the merchant with the monetary withdrawal record (block 590). For example, the recording platform (e.g., using computing resource 235, processor 320, memory 330, storage component 340, input component 350, output component 360, communication interface 370, and/or the like) may perform one or more actions based on associating the amount spent and the merchant with the monetary withdrawal record, as described above.

Process 500 may include additional implementations, such as any single implementation or any combination of implementations described below and/or in connection with one or more other processes described elsewhere herein.

In a first implementation, performing the one or more actions may include one or more of storing information identifying an association of the amount spent and the merchant with the monetary withdrawal record, organizing the account based on the information identifying the association of the amount spent and the merchant, locking the account to prevent a further monetary withdrawal by the user based on determining that spending by the user satisfies a first threshold value, denying a transaction card of the user in a transaction with the merchant based on determining that spending at the merchant satisfies a second threshold value, or permitting the user to execute transactions with the transaction card based on determining that a monetary balance associated with the user is below a third threshold value.

In a second implementation, alone or in combination with the first implementation, the identity data may be an image of the user captured at a time of the monetary withdrawal transaction, and identifying the user based on the identity data, may include identifying the user based on processing the identity data with a facial recognition technique. In a third implementation, alone or in combination with one or more of the first and second implementations, the identity data may include at least one of a personal identification number, a biometric identifier, or a transaction card identifier.

In a fourth implementation, alone or in combination with one or more of the first through third implementations, process 500 further may include determining a category associated with the merchant, and associating the amount spent with the category. In a fifth implementation, alone or in combination with one or more of the first through fourth implementations, performing the one or more actions may include generating a budget for the user based on the amount spent and the category, or updating the budget for the user based on the amount spent and the category. In a sixth implementation, alone or in combination with one or more of the first through fifth implementations, performing the one or more actions may include transmitting an alert based on determining that spending in the category satisfies a threshold value.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

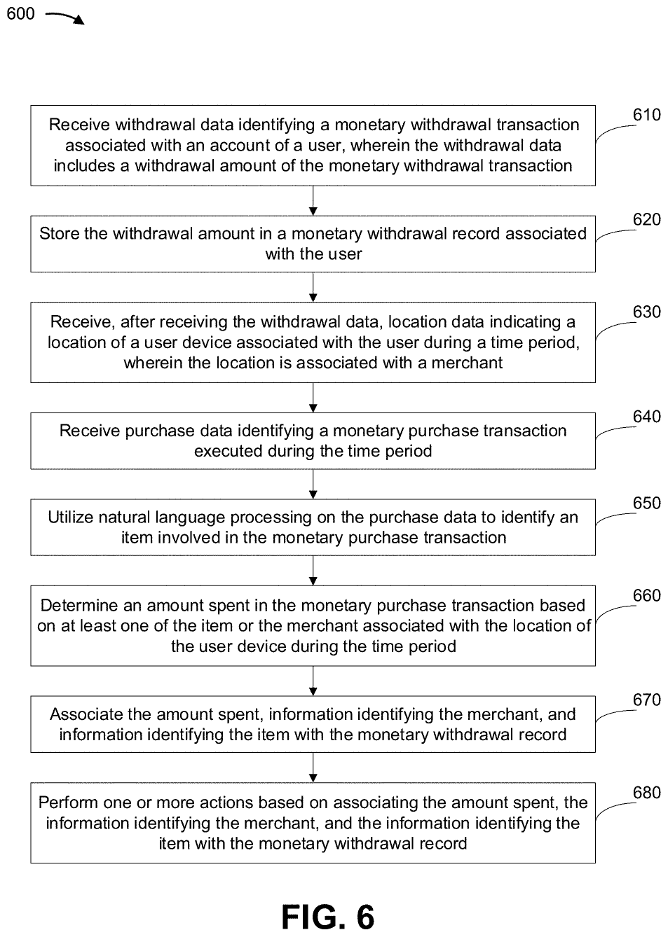

FIG. 6 is a flow chart of an example process 600 for associating merchant data or item data with a monetary transaction. In some implementations, one or more process blocks of FIG. 6 may be performed by a recording platform (e.g., recording platform 230). In some implementations, one or more process blocks of FIG. 6 may be performed by another device or a group of devices separate from or including the recording platform, such as a user device (e.g., user device 210), a transaction device (e.g., transaction device 220), and/or the like.

As shown in FIG. 6, process 600 may include receiving withdrawal data identifying a monetary withdrawal transaction associated with an account of a user, wherein the withdrawal data includes a withdrawal amount of the monetary withdrawal transaction (block 610). For example, the recording platform (e.g., using computing resource 235, processor 320, memory 330, storage component 340, input component 350, communication interface 370, and/or the like) may receive withdrawal data identifying a monetary withdrawal transaction associated with an account of a user, as described above. In some implementations, the withdrawal data includes a withdrawal amount of the monetary withdrawal transaction.

As further shown in FIG. 6, process 600 may include storing the withdrawal amount in a monetary withdrawal record associated with the user (block 620). For example, the recording platform (e.g., using computing resource 235, processor 320, memory 330, storage component 340, and/or the like) may store the withdrawal amount in a monetary withdrawal record associated with the user, as described above.

As further shown in FIG. 6, process 600 may include receiving, after receiving the withdrawal data, location data indicating a location of a user device associated with the user during a time period, wherein the location is associated with a merchant (block 630). For example, the recording platform (e.g., using computing resource 235, processor 320, memory 330, storage component 340, input component 350, communication interface 370, and/or the like) may receive, after receiving the withdrawal data, location data indicating a location of the user device during a time period, as described above. In some implementations, the location is associated with a merchant.

As further shown in FIG. 6, process 600 may include receiving purchase data identifying a monetary purchase transaction executed during the time period (block 640). For example, the recording platform (e.g., using computing resource 235, processor 320, memory 330, storage component 340, input component 350, communication interface 370, and/or the like) may receive purchase data identifying a monetary purchase transaction executed during the time period, as described above.

As further shown in FIG. 6, process 600 may include utilizing natural language processing on the purchase data to identify an item involved in the monetary purchase transaction (block 650). For example, the recording platform (e.g., using computing resource 235, processor 320, memory 330, storage component 340, and/or the like) may utilize natural language processing on the purchase data to identify an item involved in the monetary purchase transaction, as described above.

As further shown in FIG. 6, process 600 may include determining an amount spent in the monetary purchase transaction based on at least one of the item or the merchant associated with the location of the user device during the time period (block 660). For example, the recording platform (e.g., using computing resource 235, processor 320, memory 330, storage component 340, and/or the like) may determine an amount spent in the monetary purchase transaction based on at least one of the item or the merchant associated with the location of the user device during the time period, as described above.

As further shown in FIG. 6, process 600 may include associating the amount spent, information identifying the merchant, and information identifying the item with the monetary withdrawal record (block 670). For example, the recording platform (e.g., using computing resource 235, processor 320, memory 330, storage component 340, and/or the like) may associate the amount spent, information identifying the merchant, and information identifying the item with the monetary withdrawal record, as described above.

As further shown in FIG. 6, process 600 may include performing one or more actions based on associating the amount spent, the information identifying the merchant, and the information identifying the item with the monetary withdrawal record (block 680). For example, the recording platform (e.g., using computing resource 235, processor 320, memory 330, storage component 340, input component 350, output component 360, communication interface 370, and/or the like) may perform one or more actions based on associating the amount spent, the information identifying the merchant, and the information identifying the item with the monetary withdrawal record, as described above.

Process 600 may include additional implementations, such as any single implementation or any combination of implementations described below and/or in connection with one or more other processes described elsewhere herein.

In a first implementation, performing the one or more actions may include one or more of storing information identifying an association of the amount spent, the information identifying the merchant, and the information identifying the item with the monetary withdrawal record, organizing the account based on the information identifying the association of the amount spent, the information identifying the merchant, and the information identifying the item with the monetary withdrawal record, locking the account to prevent a further monetary withdrawal based on determining that spending by the user satisfies a first threshold value, denying a transaction card of the user in a transaction with the merchant based on determining that spending at the merchant satisfies a second threshold value, or permitting the user to execute transactions with the transaction card based on determining that a monetary balance associated with the user is below a third threshold value.

In a second implementation, alone or in combination with the first implementation, determining the amount spent in the monetary purchase transaction may include determining the amount spent in the monetary purchase transaction based on one or more historical transactions of the user relating to the merchant. In a third implementation, alone or in combination with one or more of the first and second implementations, determining the amount spent in the monetary purchase transaction may include determining the amount spent in the monetary purchase transaction based on one or more historical monetary purchase transactions relating to the merchant and the item. In a fourth implementation, alone or in combination with one or more of the first through third implementations, determining the amount spent in the monetary purchase transaction may include determining the amount spent in the monetary purchase transaction based on processing the information identifying the item and the information identifying the merchant with a machine-learning model.

In a fifth implementation, alone or in combination with one or more of the first through fourth implementations, the monetary withdrawal transaction may be one of an automated teller machine transaction or a cash back transaction.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, and/or the like). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method, comprising:
receiving, by a device and from a transaction device, withdrawal data identifying a monetary withdrawal transaction associated with an account of a user,
wherein the withdrawal data includes a withdrawal amount of the monetary withdrawal transaction;
storing, by the device, the withdrawal amount in a monetary withdrawal record associated with the user;
receiving, from a user device associated with the user, after receiving the withdrawal data, location data indicating a location of the user device during a time period,
wherein the location is associated with a merchant;
transmitting, by the device, a notification to the user device requesting that the user identify a monetary purchase transaction performed with the merchant based on determining that a transaction card transaction of the user did not occur during the time period;
receiving, by the device and from the user device, a response that includes purchase data identifying the monetary purchase transaction,
the purchase data including a verbal narrative or a textual narrative;
utilizing, by the device, natural language processing on the purchase data to identify an item involved in the monetary purchase transaction,
the natural language processing applied to analyze the verbal narrative or the textual narrative;
training, by the device, a machine learning model based on one or more parameters associated with the monetary purchase transaction,
the machine learning model being trained using historical transaction data as input including information identifying amounts spent, items, and merchants and to output a prediction of an amount spent in a monetary purchase transaction based on an item or a prediction of a merchant in the monetary purchase transaction;
determining, by the device and using the machine learning model, the amount spent in the monetary purchase transaction based on at the item involved in the monetary purchase transaction,
the machine learning model to receive as input information identifying the item and to output information identifying the amount spent in the monetary purchase transaction based on the item;
associating, by the device, the amount spent, the merchant, and the item with the monetary withdrawal record; and
performing, by the device, one or more actions based on associating the amount spent, the merchant, and the item with the monetary withdrawal record.

2. The method of claim 1, wherein performing the one or more actions includes one or more of:
storing information identifying an association of the amount spent, the merchant, and the item with the monetary withdrawal record,
organizing the account based on the information identifying the association of the amount spent, the merchant, and the item with the monetary withdrawal record,
locking the account to prevent a further monetary withdrawal based on determining that spending by the user satisfies a first threshold value,
denying a transaction card of the user in a transaction with the merchant based on determining that spending at the merchant satisfies a second threshold value, or
permitting the user to execute transactions with the transaction card based on determining that a monetary balance associated with the user is below a third threshold value.

3. The method of claim 2, wherein organizing the account comprises:
generating a record that includes the amount spent, the merchant, and the item; and
updating the withdrawal amount of the monetary withdrawal record with an updated withdrawal amount that is the withdrawal amount less the amount spent.

4. The method of claim 1, further comprising:
determining that the location of the user device is associated with the merchant based on global positioning system (GPS) coordinates associated with the user device and the merchant.

5. The method of claim 1, wherein the monetary withdrawal record is a first monetary withdrawal record,
wherein associating the amount spent, the merchant, and the item with the monetary withdrawal record comprises:
associating a first portion of the amount spent, the merchant, and the item with the first monetary withdrawal record and a second portion of the amount spent, the merchant, and the item with a second monetary withdrawal record based on determining that the amount spent is greater than the withdrawal amount of the first monetary withdrawal record.

6. The method of claim 1, further comprising:
determining a category associated with the item; and
associating the amount spent with the category.

7. The method of claim 6, wherein performing the one or more actions includes:
transmitting an alert to the user device based on determining that spending in the category satisfies a threshold value.

8. A device, comprising:
one or more memories; and
one or more processors, communicatively coupled to the one or more memories, to:
receive, from a transaction device, withdrawal data identifying a monetary withdrawal transaction associated with an account,
wherein the withdrawal data includes a withdrawal amount of the monetary withdrawal transaction and identity data of a user associated with the monetary withdrawal transaction;
identify the user based on the identity data;
store the withdrawal amount in a monetary withdrawal record associated with the user based on identifying the user;
receive, from a user device associated with the user, after receiving the withdrawal data, location data indicating a location of the user device during a time period,
wherein the location is associated with a merchant;
transmit a notification to the user device requesting that the user identify a monetary purchase transaction performed with the merchant based on determining that a transaction card transaction of the user did not occur during the time period;
receive, from the user device, a response that includes purchase data identifying the monetary purchase transaction,
the purchase data including a verbal narrative or a textual narrative;
train a machine learning model based on one or more parameters associated with the monetary purchase transaction,
the machine learning model being trained using historical transaction data as input including information identifying amounts spent, items, and merchants and to output a prediction of an amount spent in a monetary purchase transaction based on an item or a prediction of a merchant in the monetary purchase transaction;
utilize natural language processing on the purchase data to identify the amount spent in the monetary purchase transaction,
the natural language processing applied to analyze to the verbal narrative or the textual narrative; associate, using the machine learning model, the amount spent and the merchant with the monetary withdrawal record;
the machine learning model to receive as input information identifying the item and to output information identifying the amount spent in the monetary purchase transaction based on the item;
and
perform one or more actions based on associating the amount spent and the merchant with the monetary withdrawal record.

9. The device of claim 8, wherein the one or more processors, when performing the one or more actions, are to one or more of:
store information identifying an association of the amount spent and the merchant with the monetary withdrawal record,
organize the account based on the information identifying the association of the amount spent and the merchant,
lock the account to prevent a further monetary withdrawal by the user based on determining that spending by the user satisfies a first threshold value,
deny a transaction card of the user in a transaction with the merchant based on determining that spending at the merchant satisfies a second threshold value, or
permit the user to execute transactions with the transaction card based on determining that a monetary balance associated with the user is below a third threshold value.

10. The device of claim 8, wherein the identity data is an image of the user captured by the transaction device at a time of the monetary withdrawal transaction,
wherein the one or more processors, when identifying the user based on the identity data, are to:
identify the user based on processing the identity data with a facial recognition technique.

11. The device of claim 8, wherein the identity data includes at least one of:
a personal identification number,
a biometric identifier, or
a transaction card identifier.

12. The device of claim 8, wherein the one or more processors are further to:
determine a category associated with the merchant; and
associate the amount spent with the category.

13. The device of claim 12, wherein the one or more processors, when performing the one or more actions, are to:
generate a budget for the user based on the amount spent and the category, or
update the budget for the user based on the amount spent and the category.

14. The device of claim 12, wherein the one or more processors, when performing the one or more actions, are to:
transmit an alert to the user device based on determining that spending in the category satisfies a threshold value.

15. A non-transitory computer-readable medium storing instructions, the instructions comprising:
one or more instructions that, when executed by one or more processors, cause the one or more processors to:
receive, from a transaction device, withdrawal data identifying a monetary withdrawal transaction associated with an account of a user,
wherein the withdrawal data includes a withdrawal amount of the monetary withdrawal transaction;
store the withdrawal amount in a monetary withdrawal record associated with the user;
receive, from a user device associated with the user, after receiving the withdrawal data, location data indicating a location of the user device during a time period,
wherein the location is associated with a merchant;
receive, from the user device of the user, purchase data identifying a monetary purchase transaction executed during the time period,
the purchase data including a verbal narrative or a textual narrative;
utilize natural language processing on the purchase data to identify an item involved in the monetary purchase transaction,
the natural language processing applied to analyze the verbal narrative or the textual narrative;
train a machine learning model based on one or more parameters associated with the monetary purchase transaction,
the machine learning model being trained using historical transaction data as input including information identifying amounts spent, items, and merchants and to output a prediction of an amount spent in a monetary purchase transaction based on an item or a prediction of a merchant in the monetary purchase transaction;
determine, using the machine learning model, the amount spent in the monetary purchase transaction based on at least one of the item or the merchant associated with the location of the user device during the time period,
the machine learning model to receive as input information identifying the item and to output information identifying the amount spent in the monetary purchase transaction based on the item;
associate the amount spent, information identifying the merchant, and information identifying the item with the monetary withdrawal record; and
perform one or more actions based on associating the amount spent, the information identifying the merchant, and the information identifying the item with the monetary withdrawal record.

16. The non-transitory computer-readable medium of claim 15, wherein the one or more instructions, that cause the one or more processors to perform the one or more actions, cause the one or more processors to one or more of:
store information identifying an association of the amount spent, the information identifying the merchant, and the information identifying the item with the monetary withdrawal record,
organize the account based on the information identifying the association of the amount spent, the information identifying the merchant, and the information identifying the item with the monetary withdrawal record,
lock the account to prevent a further monetary withdrawal based on determining that spending by the user satisfies a first threshold value,
deny a transaction card of the user in a transaction with the merchant based on determining that spending at the merchant satisfies a second threshold value, or
permit the user to execute transactions with the transaction card based on determining that a monetary balance associated with the user is below a third threshold value.

17. The non-transitory computer-readable medium of claim 15, wherein the one or more instructions, that cause the one or more processors to determine the amount spent in the monetary purchase transaction, cause the one or more processors to:
determine the amount spent in the monetary purchase transaction based on one or more historical transactions of the user relating to the merchant.

18. The non-transitory computer-readable medium of claim 15, wherein the one or more instructions, that cause the one or more processors to determine the amount spent in the monetary purchase transaction, cause the one or more processors to:
determine the amount spent in the monetary purchase transaction based on one or more historical monetary purchase transactions relating to the merchant and the item.

19. The non-transitory computer-readable medium of claim 15, wherein the one or more instructions, that cause the one or more processors to determine the amount spent in the monetary purchase transaction, cause the one or more processors to:
determine the amount spent in the monetary purchase transaction based on processing the information identifying the item and the information identifying the merchant with a machine-learning model.

20. The non-transitory computer-readable medium of claim 15, wherein the monetary withdrawal transaction is one of:
an automated teller machine transaction, or
a cash back transaction.
